(19) United States
(12) Patent Application Publication
(10) Pub. No.: US 2022/0327862 A1
(43) Pub. Date: Oct. 13, 2022

(54) METHOD FOR DETECTING WHETHER A FACE IS MASKED, MASKED-FACE RECOGNITION DEVICE, AND COMPUTER STORAGE MEDIUM

(71) Applicant: HONG FU JIN PRECISION INDUSTRY (WuHan) CO., LTD., Wuhan (CN)

(72) Inventor: CHIN-WEI YANG, New Taipei (TW)

(21) Appl. No.: 17/555,656

(22) Filed: Dec. 20, 2021

Related U.S. Application Data
(63) Continuation-in-part of application No. PCT/CN2021/086113, filed on Apr. 9, 2021.

(51) Int. Cl. G06V 40/16; G06V 10/32; G06V 10/774; G06V 10/22

(52) U.S. Cl. CPC G06V 40/172; G06V 10/32; G06V 10/774; G06V 10/22

(57) ABSTRACT

A method for detecting whether a face is masked includes acquiring a face image to be recognized; performing face detection on the face image to be recognized to determine a first face area; preprocessing the first face area to obtain a first square face image; performing face recognition on the first square face image using a face recognition model and outputting a result of recognition or non-recognition. The method of the present disclosure obtains a square face area by preprocessing face detection results, optimizing the process flow of masked-face recognition, and improves the accuracy of recognition.

### FIELD

The present disclosure relates to image processing technology, in particular to a method for detecting whether a face is masked, a masked-face recognition device, and a computer storage medium.

### BACKGROUND

With the rapid development of computer technology, face recognition technology is more and more widely used for monitoring system, attendance record, sitting examination, and other occasions where identity needs to be verified.

However, Coronavirus disease (Covid-19) has been raging in the world, resulting in serious economic, property, and life losses and threats. As a simple, effective, and low-cost epidemic prevention measure, wearing masks to prevent infection and slow transmission of Covid-19 is expected to remain for a long time in the future. Various scenes require the face recognition technology to be upgraded. For example, a person may need to be reminded to wear a mask on a specific occasion or in a place, and masked faces and non-masked faces need to be compared with different databases in the process of face recognition.

### SUMMARY

The present disclosure provided a method for detecting whether a face is masked, which reduces the probability of misjudgments by figures in authority by improving the accuracy of judgments in removing unnecessary information and focusing on key areas.

The method for detecting whether a face is masked comprises: acquiring a face image to be recognized; performing face detection on the face image to be recognized to determine a first face area; preprocessing the first face area to obtain a first square face image; performing face recognition on the first square face image using a face recognition model and outputting a result of recognition or non-recognition.

In at least one embodiment, the step of “preprocessing the first face area” comprises: modifying coordinates of the first face area and enlarging a range of the first face area to obtain a first square face image area; isolating the first square face image area from the face image to be recognized; zooming the first square face image area to obtain the first square face image, an image specification of the first square face image to meet input requirements of a Yolo framework.

In at least one embodiment, the face recognition model is trained, and training of the face recognition model comprises: obtaining masked face sample images; preprocessing the masked face sample images to obtain a second square image; labeling a mask in the second square image using a labeling tool; configuring the Yolo framework and training the Yolo framework with the labeled second square image to obtain the face recognition model.

In at least one embodiment, the step of “preprocessing the masked face sample images” comprises: performing face detection on each masked face sample image to be processed to determine a second face area; modifying coordinates of the second face area and enlarging a range of the second face area to obtain a second square face image area; isolating the second square face image area from the masked face sample image; zooming the second square face image area to obtain a second square face image, an image specification of the second square face image to meet the input requirements of the Yolo framework.

In at least one embodiment, the step of isolating a square face image area comprises: isolating the square face image area using a region of interest function of OpenCV.

In at least one embodiment, the step of zooming the first square face image area comprises: zooming the first square face image area using a cv2.resize function of OpenCV:

In at least one embodiment, the masked face sample image is divided into a training set and a test set. The training set is used to train the face recognition model, and the test set is used to test the recognition accuracy of the face recognition model.

In at least one embodiment, the step of “modifying coordinates of the second face area” comprises compensating for a height of the second face area.

The present disclosure provides a masked-face recognition device, the masked-face recognition device includes a processor and a memory, the memory stores several computer-readable instructions, and the processor is configured to execute the computer-readable instructions stored in the memory to perform the steps of the method for detecting whether a face is masked.

The present disclosure provides a computer storage medium for storing computer-readable instructions. When the instructions are executed, the steps of the method for detecting whether a face is masked are executed.

Compared with the related art, the method for detecting whether a face is masked, the masked-face recognition device, and the computer storage medium of the present disclosure perform with high accuracy in recognition of faces that are masked by optimizing the training model of recognition of masks and mainly analyzing key areas, so as to expand the range of application of face recognition.

### BRIEF DESCRIPTION OF THE DRAWINGS

The above and/or additional aspects and advantages of the disclosure will become apparent and easy to understand from the description of the embodiments in combination with the following drawings, wherein:

FIG. 1 is a flowchart of a method for detecting whether a face is masked in an embodiment of the present disclosure.

FIG. 2 is a flowchart of preprocessing a face area in the method shown in FIG. 1.

FIG. 3 is a flowchart of training a face recognition model in the method.

FIG. 4 is a flowchart of preprocessing face sample image including mask in the method.

FIG. 5 is a comparison diagram between a face area in an image to be recognized and an image of a square face in the method.

FIG. 6 is a schematic diagram of a masked-face recognition device in an embodiment of the present disclosure.

### LABELS OF COMPONENTS

| | |
|---|---|
| masked-face recognition device | 100 |
| processor | 1001 |
| storage | 1002 |
| communication bus | 1003 |
| camera | 1004 |
| computer program | 1005 |
| face area | 200 |
| square image having the face area | 300 |

The following exemplary embodiments in combination with the above drawings will further explain the present disclosure.

### DETAILED DESCRIPTION

In order to better understand the above objects, features and advantages of the disclosure, the disclosure is described in combination with the drawings and exemplary embodiments. It should be noted that the embodiments of the present disclosure and the features in the embodiments can be combined with each other without conflict.

Many specific details are set forth in the following description to facilitate a full understanding of the disclosure. The described embodiments are only part of the embodiments of the disclosure, and not all of them.

Unless otherwise defined, all technical and scientific terms used herein have the same meanings as those generally understood by those skilled in the art of the present disclosure. The terms used in the description of the disclosure herein are only for the purpose of describing exemplary embodiments, and are not intended to limit the disclosure.

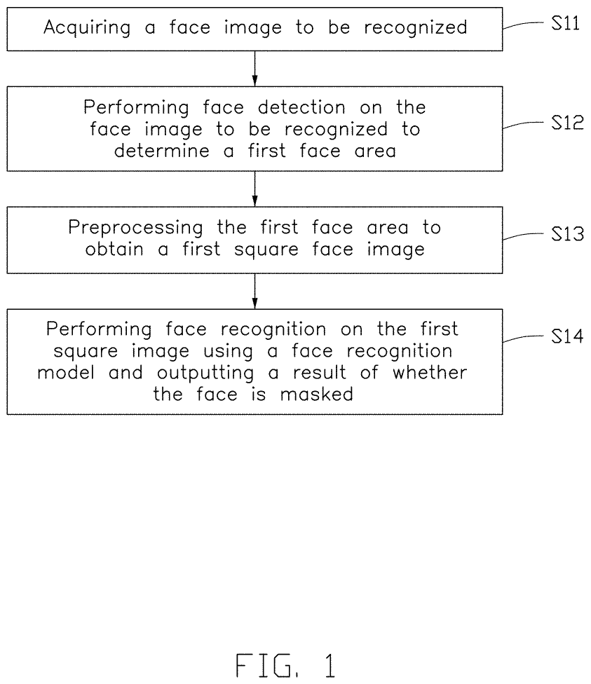

Referring to FIG. 1, a method for detecting whether a face is masked includes:

S11: acquiring a face image to be recognized;

S12: performing face detection on the face image to be recognized to determine a first face area;

S13: preprocessing the first face area to obtain a first square face image;

S14: performing face recognition on the first square image using a face recognition model and outputting a result of whether the face is masked.

In the method provided in the present disclosure, step S13 is added to the conventional face recognition method to preprocess a face area to obtain a square image. The face recognition model in step S14 can be obtained through YOLOv3 training. The input of YOLOv3 is required to be a square image. Therefore, the preprocessing step effectively optimizes the use of the model, reduces the number of steps, maintains image quality, and then maintains the accuracy of model recognition. YoLo (you only look once) is an object detection algorithm, which is based on a separate end-to-end network to realize the input from the original image to the output of object position and category. It has the advantages of fast operation speed, low background error detection rate, and good universality.

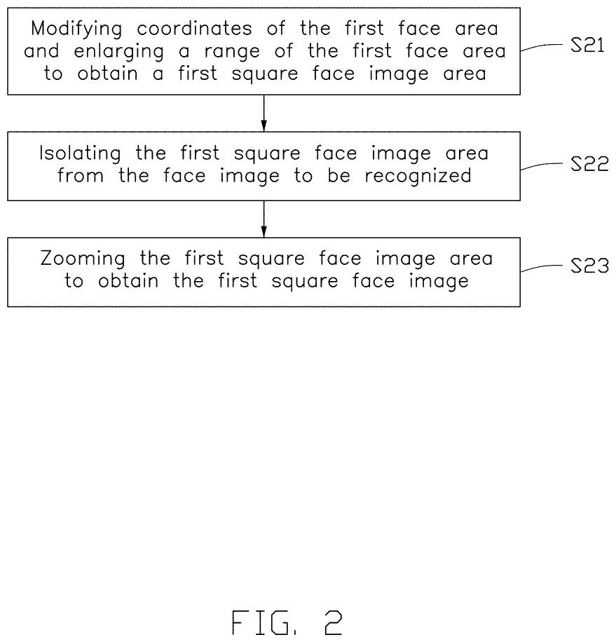

Referring to FIG. 2, in one embodiment, the step of preprocessing the first face area in the method includes:

S21: modifying coordinates of the first face area and enlarging a range of the first face area to obtain a first square face image area;

S22: isolating the first square face image area from the face image to be recognized;

S23: zooming the first square face image area to obtain the first square face image. An image specification of the first square face image thus meets input requirements of a Yolo framework.

In this embodiment, a face area is optimized and expanded into a square face image area through coordinate correction to meet the input requirements of a yolov3 framework. The manner of coordinate correction is to record the coordinates of a rectangular face area as x1, x2, y1, and y2, where x1 is the lower left coordinate, x2 is the upper left coordinate, y1 is the lower right coordinate, and y2 is the upper right coordinate. Therefore, the height (h) of the area is “y2−y1” and the width (w) is “x2−x1”. The selection range of a new area is square, and the coordinates of a square face image area are, x1_new=int (x1+(w*0.5−h*0.5)) x2_new=int (x1+(w*0.5+h*0.5)) y1, y2.

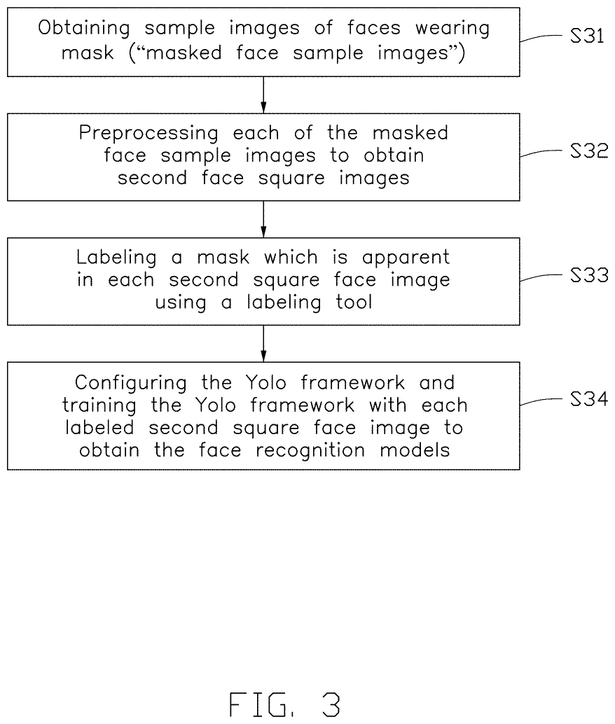

Referring to FIG. 3, in one embodiment, the step of training face recognition models includes:

S31: obtaining sample images of faces wearing mask (“masked face sample images”);

S32: preprocessing each of the masked face sample images to obtain second face square images;

S33: labeling a mask which is apparent in each second square face image using a labeling tool;

S34: configuring the Yolo framework and training the Yolo framework with each labeled second square face image to obtain the face recognition models.

Steps S31 to S34 train the yolov3 through the masked face sample image. Because the mask is labeled in the masked face sample image, the face recognition model has a function of recognizing a mask on a face. For the input image, the mask can be labeled. In the training process, images containing masks of different colors and shapes are collected as much as possible for training, so as to achieve better recognition effect.

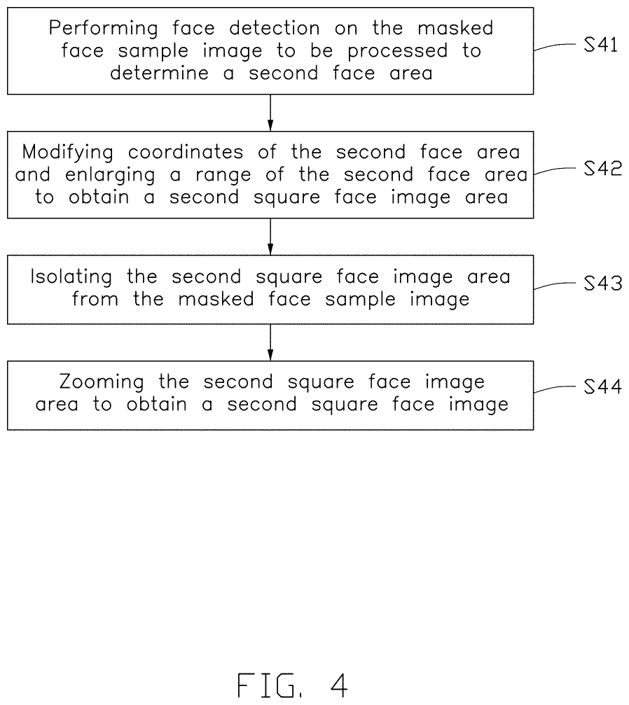

Referring to FIG. 4, in one embodiment, the step of preprocessing the masked face sample image includes:

S41: performing face detection on the masked face sample image to be processed to determine a second face area;

S42: modifying coordinates of the second face area and enlarging a range of the second face area to obtain a second square face image area;

S43: isolating the second square face image area from the masked face sample image;

S44: zooming the second square face image area to obtain a second square face image. An image specification of the second square face image meets the input requirements of the Yolo framework.

Steps S42 to S44 are the same as steps S21 to S23, they are the same methods of image processing for different face images or regions of the face respectively.

In one embodiment, the step of isolating a square face image area includes: isolating the square face image area using a region of interest function of OpenCV.

In this embodiment, the region of interest function (ROI) can be used to color and isolate the square face image area. A ROI is a common function in visual algorithms. Generally, a region is selected from a wider image range as the focus of subsequent image analysis. The ROI has the advantages of reducing processing time and increasing accuracy of calculation.

In one embodiment, the step of zooming the first square face image area includes: zooming the first square face image area using a cv2.resize function of OpenCV.

The resize function is a function designed to adjust the size of an image in OpenCV. In this embodiment, the cv2.resize function is used to zoom a square face image area in order to obtain a square image area with a resolution of 416*416. The resolution of 416*416 conforms to the width and height of the input image of yolov3 algorithm. In the present disclosure, the image area obtained by preprocessing is square rather than rectangular, so that when using the yolov3 algorithm, there will be no deformation caused by stretching due to image zooming, the image will not be distorted, more face details can be left in, and therefore, higher face recognition accuracy can be achieved.

In one embodiment, the masked face sample images are divided into a training set and a test set. The training set is used to train the face recognition model, and the test set is used to test the recognition accuracy of the face recognition model. Generally, 80%/20% proportions are used to divide the masked face sample images, 80% of the masked face sample images is the training set and 20% of the masked face sample images is the test set, so as to make full use of limited samples.

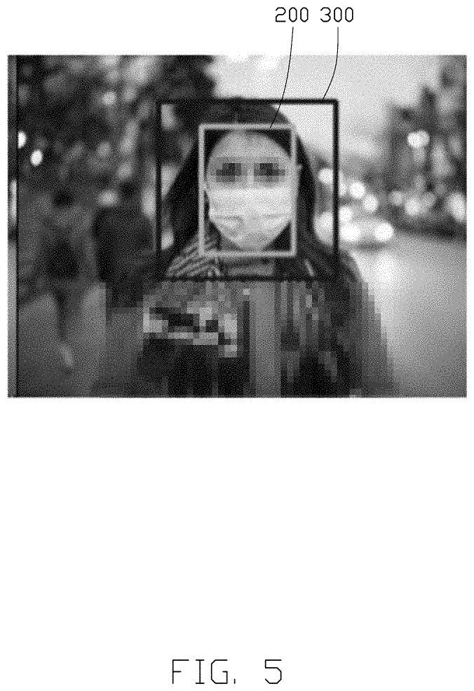

In one embodiment, modifying coordinates of a face area includes: compensating a height of the face area. In order to avoid some faces not being selected during face detection, during compensation for the face area, a compensation algorithm with a face compensation coefficient of 0.1 and the compensated image height is offset_h=int(0.1*h) is adopted. The calculation process is x1_offset=x1_new−offset_h, y1_offset=y1−offset_h. The final coordinates of the compensated square face area are: upper left coordinates (x1_offset, y1_offset), lower right coordinates (x2_new+offset_h, Y2+offset_h). As shown in FIG. 5, a face area 200 is a rectangular inner ring, and a square face image area 300 after preprocessing and compensation algorithm is a square outer ring.

In this embodiment, the value of the face compensation coefficient can be set according to actual demand, and is not limited to 0.1.

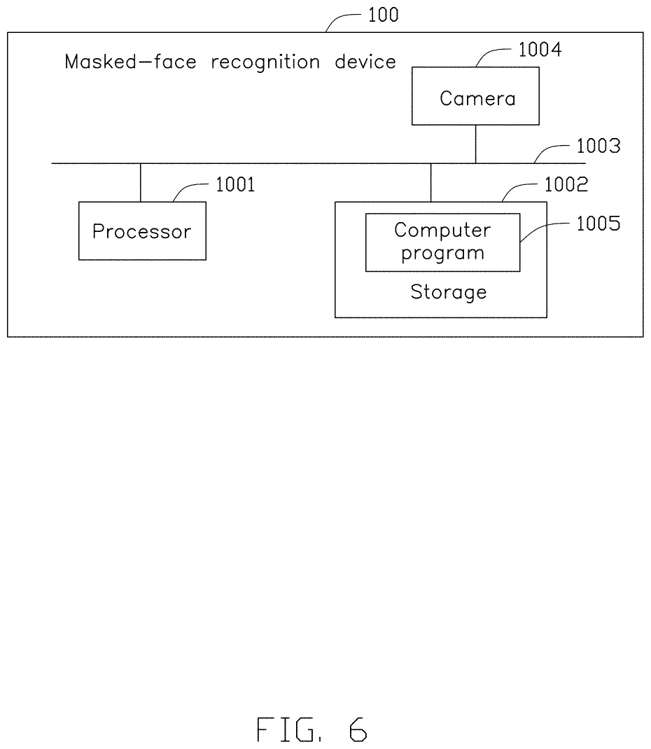

Referring to FIG. 6, a hardware structure of a masked-face recognition device 100 is provided in the embodiment of the present disclosure. As shown in FIG. 6, the masked-face recognition device 100 may include a processor 1001, a storage 1002, a communication bus 1003, and a camera 1004. The camera 1004 may be a CMOS or CCD camera. The storage 1002 is used to store one or more computer programs 1005. The one or more computer programs 1005 are configured to be executed by the processor 1001. The one or more computer programs 1005 may include instructions that may be used to implement the method for detecting whether a face is masked in the masked-face recognition device 100.

It can be understood that the structure illustrated in the present embodiment does not limit the masked-face recognition device 100. In other embodiments, the masked-face recognition device 100 may include more or fewer components than shown, or combine some components, or split some components, or have different component arrangements.

The processor 1001 may include one or more processing units. For example, the processor 1001 may include a disclosure processor (AP), a graphics processing unit (GPU), an image signal processor (ISP), a controller, a video codec, a DSP, a CPU, a baseband processor, and/or a neural network processor (neural network processing unit, NPU), etc. Different processing units can be independent devices or integrated in one or more processors.

The processor 1001 may also be provided with a memory for storing instructions and data. In some embodiments, the memory in the processor 1001 is a cache memory. The memory can store instructions or data created or used or recycled by the processor 1001. If the processor 1001 needs to use the instructions or data again, it can be called up directly from the memory, which avoids repeated access, the waiting time of the processor 1001 is reduced, thereby improving the efficiency of the system.

In some embodiments, the processor 1001 may include one or more interfaces. The interface may include an integrated circuit (I2C) interface, an integrated circuit sound (I2S) interface, a pulse code modulation (PCM) interface, a universal asynchronous receiver/transmitter (UART) interface, and a mobile industry processor interface (MIPI), general purpose input/output (GPIO) interface, SIM interface, and/or USB interface, etc.

In some embodiments, the storage 1002 may include random access memory, and may also include nonvolatile memory, such as hard disk, memory, plug-in hard disk, smart media card (SMC), secure digital (SD) card, and flash card, at least one disk storage device, flash memory device, or other volatile solid-state storage device.

The present disclosure also provides a computer storage medium. The computer storage medium stores computer instructions. When the computer instructions run on an electronic device, the electronic device performs the above embodiment of steps of method to perform the method for detecting whether a face is masked.

All or part of the steps in the method of the above embodiments in the present disclosure also can be completed through a computer program for instructing relevant hardware. The computer program can be stored in a computer-readable storage medium. When the computer program is executed by a processor, it can perform the steps of the above method. The computer program includes computer program code, which can be in the form of source code, object code, executable file or some intermediate forms, etc. The computer-readable medium may include any entity or device capable of carrying the computer program code, recording medium, U disk, mobile hard disk, magnetic disk, optical disk, computer memory, read only memory (ROM), random access memory (RAM), electric carrier signal, telecommunication signal, software distribution medium, etc. It should be noted that the content contained in the computer-readable medium can be increased or decreased according to the requirements of legislation and patent practice in jurisdictions. For example, in some jurisdictions, according to legislation and patent practice, a computer-readable medium does not include electric carrier signals and telecommunication signals.

In the several embodiments provided by the present disclosure, it should be understood that the disclosed computer devices and methods can be implemented in other ways. For example, the embodiment of the computer device described above is only schematic. For example, the division of the unit is only a logical function division, and there may be other division modes in actual implementation.

In addition, each functional unit in each embodiment of the disclosure can be integrated in the same processing unit, each unit can exist separately, or two or more units can be integrated in the same unit. The above integrated units can be performed in the form of hardware or hardware plus software function modules.

It will be obvious to those skilled in the art that the disclosure is not limited to the details of the above exemplary embodiments, and the disclosure can be performed in other specific forms without departing from the spirit or basic features of the disclosure. Therefore, from any point of view, the embodiments should be regarded as exemplary and non limiting. In addition, it is clear that the word “including” does not exclude other units or steps, and the singular does not exclude the plural. The multiple units or computer devices stated in claims of the computer device may also be implemented by the same unit or computer device through software or hardware. Words such as “first”, “second” are used for naming, not any specific order.

Finally, it should be noted that the above embodiments are only used to illustrate the technical scheme of the disclosure rather than limitation. Although the disclosure has been described in detail with reference to the preferred embodiment, those skilled in the art should understand that the technical scheme of the disclosure can be modified or replaced with equivalent embodiments without departing from the spirit and scope of the technical scheme of the disclosure.

What is claimed is:

1. A method for detecting whether a face is masked, comprising:
acquiring a face image to be recognized;
performing face detection on the face image to be recognized to determine a first face area;
preprocessing the first face area to obtain a first square face image;
performing face recognition on the first square face image using face recognition models; and
outputting a recognition result of whether the face is masked.

2. The method for detecting whether the face is masked of claim 1, wherein preprocessing the first face area comprises:
modifying coordinates of the first face area and enlarging a range of the first face area to obtain a first square face image area;
isolating the first square face image area from the face image to be recognized;
zooming the first square face image area to obtain the first square face image, an image specification of the first square face image meets input requirements of a Yolo framework.

3. The method for detecting whether the face is masked of claim 1, wherein the face recognition models are trained, and training of the face recognition models comprises:
obtaining masked face sample images;
preprocessing each masked face sample image to obtain second square face images;
labeling a mask in each second square image using a labeling tool;
configuring a Yolo framework and training the Yolo framework with each labeled second square image to obtain the face recognition models.

4. The method for detecting whether the face is masked of claim 3, wherein preprocessing the masked face sample image comprises:
performing face detection on the masked face sample image to determine a second face area;
modifying coordinates of the second face area and enlarging a range of the second face area to obtain a second square face image area;
isolating the second square face image area from the masked face sample image;
zooming the second square face image area to obtain the second square face image, an image specification of the second square face image meets input requirements of the Yolo framework.

5. The method for detecting whether the face is masked of claim 2, wherein isolating a square face image area comprises:
isolating the square face image area using a region of interest function of OpenCV.

6. The method for detecting whether the face is masked of claim 2, wherein zooming the first square face image area comprises:
zooming the first square face image area using a cv2.resize function of OpenCV.

7. The method for detecting whether the face is masked of claim 3, wherein the masked face sample images are divided into a training set and a test set, the training set is used to train the face recognition model, and the test set is used to test recognition accuracy of the face recognition model.

8. The method for detecting whether the face is masked of claim 4, wherein modifying coordinates of the second face area comprises:
compensating a height of the second face area.

9. A masked-face recognition device comprising a processor and a storage storing computer-readable instructions, wherein the processor is configured to execute the computer-readable instructions stored in the storage to:
acquire a face image to be recognized;
perform face detection on the face image to be recognized to determine a first face area;
preprocess the first face area to obtain a first square face image;
perform face recognition on the first square face image using face recognition models; and
output a recognition result of whether the face is masked.

10. The masked-face recognition device of claim 9, wherein preprocess the first face area comprises:
modify coordinates of the first face area and enlarging a range of the first face area to obtain a first square face image area;
isolate the first square face image area from the face image to be recognized;
zoom the first square face image area to obtain the first square face image, an image specification of the first square face image meets input requirements of a Yolo framework.

11. The masked-face recognition device of claim 9, wherein the face recognition models are trained, wherein the processor further is configured to execute the plurality of computer-readable instructions stored in the storage to:
obtain masked face sample images;
preprocess each masked face sample image to obtain second square face images;
label a mask in each second square image using a labeling tool;
configure a Yolo framework and training the Yolo framework with each labeled second square image to obtain the face recognition models.

12. The masked-face recognition device of claim 11, wherein, wherein preprocess the masked face sample image comprises:
perform face detection on the masked face sample image to determine a second face area;
modify coordinates of the second face area and enlarging a range of the second face area to obtain a second square face image area;
isolate the second square face image area from the masked face sample image;
zoom the second square face image area to obtain the second square face image, an image specification of the second square face image meets input requirements of the Yolo framework.

13. The masked-face recognition device of claim 10, wherein isolate a square face image area comprises:
isolate the square face image area using a region of interest function of OpenCV.

14. The masked-face recognition device of claim 10, wherein zoom the first square face image area comprises:
zoom the first square face image area using a cv2.resize function of OpenCV.

15. The masked-face recognition device of claim 11, wherein the masked face sample images are divided into a training set and a test set, the training set is used to train the face recognition model, and the test set is used to test recognition accuracy of the face recognition model.

16. The masked-face recognition device of claim 12, wherein modify coordinates of the second face area comprises:
compensate a height of the second face area.

17. A computer storage medium for storing computer-readable instructions, wherein when the computer-readable instructions are executed, the computer-readable instructions are executed to:
acquire a face image to be recognized;
perform face detection on the face image to be recognized to determine a first face area;
preprocess the first face area to obtain a first square face image;
perform face recognition on the first square face image using face recognition models; and
output a recognition result of whether the face is masked.
